(19) United States
(12) Patent Application Publication
(10) Pub. No.: US 2014/0251741 A1
(43) Pub. Date: Sep. 11, 2014

(54) FLUID-TYPE SHOCK ABSORBER, PARTICULARLY FOR DOORS OF ELECTRICAL HOUSEHOLD APPLIANCES

(71) Applicant: BRERA CERNIERE S.R.L., Milano (IT)

(72) Inventor: Roberto Piero BRERA, Milano (IT)

(73) Assignee: BRERA CERNIERE S.R.L., Milano (IT)

(21) Appl. No.: 14/198,110

(22) Filed: Mar. 5, 2014

(30) Foreign Application Priority Data
Mar. 7, 2013 (IT) MI2013A000344

(51) Int. Cl. F16F 9/516; F16F 9/19; F16F 9/34

(52) U.S. Cl. CPC F16F 9/516; F16F 9/3405; F16F 9/19
USPC 188/282.1

(57) ABSTRACT

A fluid-type shock absorber, particularly for doors of electrical household appliances, comprising a shock absorber body, in which a substantially cylindrical chamber is defined that accommodates coaxially a piston provided with a stem that protrudes from at least one axial end of the chamber, the piston divides the chamber into two parts, the piston is accommodated so that it can slide axially within the chamber, moreover at least one duct is provided for connecting the two parts of the chamber in order to allow the transit of a fluid from one part to the other of the chamber for the axial sliding of the piston with respect to the shock absorber body, the connecting duct is defined in the piston and has a calibrated portion thereof that is defined on a first end face of the piston, elements are provided for varying the passage section of the connecting duct available for the fluid.

### CROSS-REFERENCE TO RELATED APPLICATIONS

This application claims priority to Italian Patent Application No. MI2013A000344 filed Mar. 7, 2013, the disclosure of which is hereby incorporated in its entirety by reference herein.

### TECHNICAL FIELD

The present invention relates to a fluid-type shock absorber, particularly for doors of electrical household appliances such as ovens, dishwashers or the like or for furniture components such as cabinet doors or drawers, with great simplicity of production.

### BACKGROUND

Fluid-type shock absorbers are known which are used in particular for damping the closing movement of cabinet doors or drawers of items of furniture, but also for doors of electrical household appliances like ovens and dishwashers.

Some conventional types of shock absorbers comprise a body or housing that is substantially cylindrical in shape and in which is defined a first cylindrical chamber that accommodates, slideably, a piston the stem of which protrudes from an axial end of the housing and is connectable to the item that it is to damp. The piston axially delimits a part of the first chamber in which a fluid is contained, and such part of the first chamber is connected, through holes of calibrated diameter, with a second chamber that, in some types of shock absorbers, is arranged around the first chamber and, in other types of shock absorbers, extends partially around the first chamber and partially inside the housing at the other end from the first chamber with respect to the piston. In the second chamber there is an elastically deformable element, such as for example a sponge, or the second chamber is delimited by an elastically deformable element, such as for example a membrane, so that the useful volume of the second chamber can vary in order to exchange fluid with the first chamber.

Other types of shock absorbers comprise a shock absorber body that is substantially cylindrical in shape and in which is defined a cylindrical chamber that coaxially accommodates, slideably, a piston that divides such chamber into two chambers, which are arranged on mutually opposite sides with respect to the piston. These two parts of the chamber are connected to each other by way of a calibrated connection passage that, generally, is defined in the shock absorber body.

In essence, in these types of shock absorbers, the axial movement of the piston with respect to the housing brings about a transfer of fluid from one chamber or part of chamber to another chamber or part of chamber through one or more calibrated holes or passages. The passage of the fluid through the calibrated holes or passages dissipates kinetic energy, thus actuating the braking of the piston. The braking of the axial movement of the piston in one direction is used to actuate the damping of the item that is connected to the stem of the piston, while the axial movement of the piston in the opposite direction, or reset movement, in order to prevent an unwanted damping effect on the item that is connected to the stem of the piston, is assisted or induced completely by a reset spring that is interposed between the piston and the housing.

The design and production of these shock absorbers, in particular in the field of furniture and electrical household appliances, where the space occupation of shock absorbers needs to be contained, often encounter problems that are not easy to solve.

One of the problems that is found in these types of shock absorbers is the difficulty of reconciling the requirement of having reduced encumbrances with the requirement of having an adequate damping force.

Another problem is the difficulty of making the calibrated holes or ducts in the shock absorber body. This production difficulty inevitably raises the production costs of these shock absorbers.

An additional problem is the difficulty of obtaining, in a shock absorber of contained size, adequate mechanical strength to enable the shock absorber to withstand impulse stresses, particularly for liquid-type shock absorbers.

Yet another problem is the time required for resetting the shock absorber by the action of the reset spring. In fact, owing to the fact that the connection between the chambers or the parts of chambers is achieved by way of calibrated holes or passages, the cross-section of which for the passage of the fluid needs to be small enough to obtain a good damping effect, in order to reset rapidly it is necessary to use a reset spring that is capable of developing a strong force. This constitutes, generally, a problem in that the force of the reset spring is a force to be defeated during the actuation of the item that has to be damped.

### SUMMARY

The aim of the present invention is to solve the above mentioned problems, by providing a fluid-type shock absorber, particularly for doors of electrical household appliances such as ovens, dishwashers or the like or for furniture components such as cabinet doors or drawers, which is capable of developing a strong braking force with a contained space occupation and which is simple to make.

Within this aim, an object of the invention is to provide a fluid-type shock absorber that has a reset movement that is sufficiently rapid without necessarily requiring the application of a strong force.

Another object of the invention is to provide a fluid-type shock absorber that can be produced at very low cost.

A further object of the invention is to provide a fluid-type shock absorber that ensures a long lifetime and a high reliability of operation.

This aim and these and other objects which will become better apparent hereinafter, are achieved by a fluid-type shock absorber, particularly for doors of electrical household appliances such as ovens, dishwashers or the like or for furniture components such as cabinet doors or drawers, which comprises a shock absorber body that has internally a substantially cylindrical chamber that accommodates coaxially a piston provided with a stem that protrudes from at least one axial end of the chamber; the piston dividing the chamber into two parts arranged on mutually opposite sides with respect to the piston along the axis of the chamber and containing a fluid; the piston being accommodated so that it can slide axially within the chamber; at least one duct being provided for connecting the two parts of the chamber in order to allow the transit of the fluid from one part to the other of the chamber for the axial sliding of the piston with respect to the shock absorber body, characterized in that the at least one connecting duct is defined in the piston and has a calibrated portion thereof that is defined on a first end face of the piston, means being provided for varying the passage section of the connecting duct available for the fluid; the means for varying the passage section of the connecting duct, depending on the direction of axial sliding of the piston in the chamber, being engageable or disengageable with the first end face of the piston in order to channel the transit of the fluid along the calibrated portion or in order to also allow the transit of the fluid outside the calibrated portion

### BRIEF DESCRIPTION OF THE DRAWINGS

Further characteristics and advantages of the invention will become better apparent from the description of a preferred, but not exclusive, embodiment of the shock absorber according to the invention, which is illustrated by way of non-limiting example in the accompanying drawings wherein:

FIG. 1 is a perspective view of the shock absorber according to the invention;

FIG. 2 is an exploded perspective view of the shock absorber according to the invention;

FIG. 3 is another exploded perspective view of the shock absorber according to the invention, but seen from a different angle with respect to FIG. 2;

FIG. 4 is an axial cross-sectional view of the shock absorber according to the invention in the inactive condition;

FIG. 5 is an axial cross-sectional view of the shock absorber according to the invention in an active condition;

FIG. 6 is an axial cross-sectional view of the shock absorber according to the invention in a different active condition from that shown in FIG. 5.

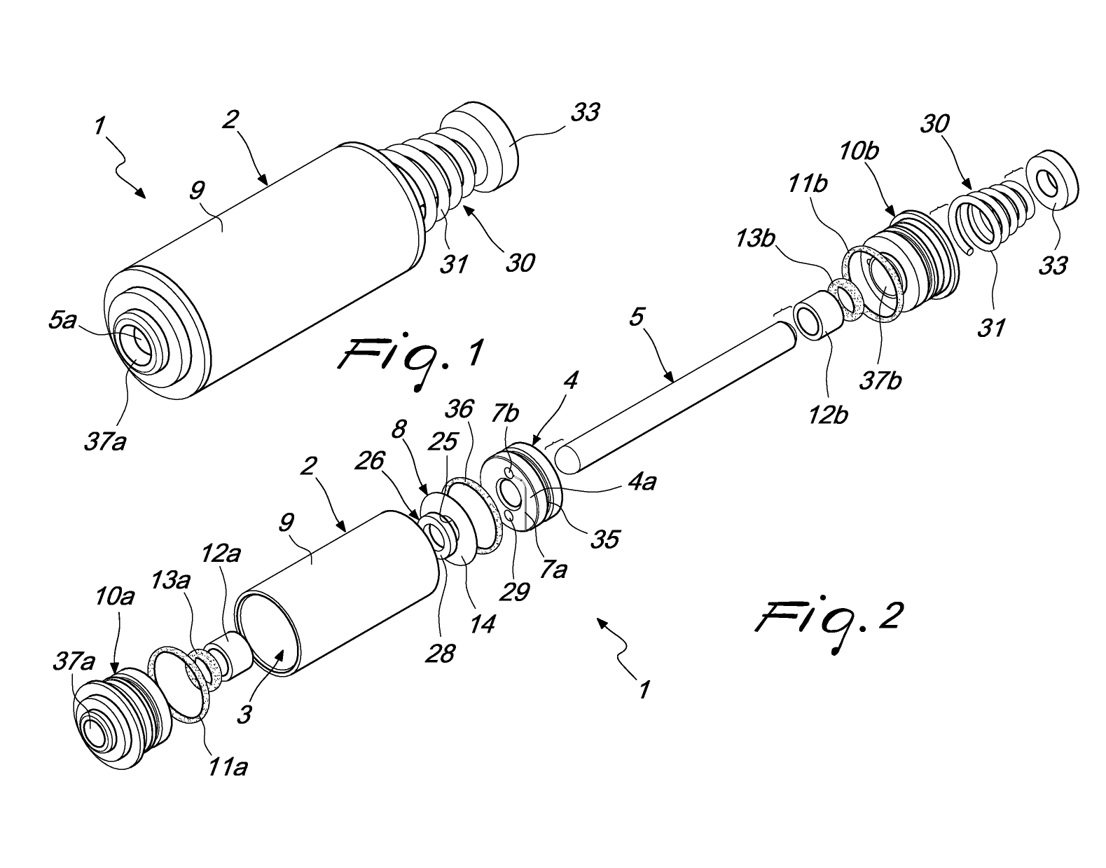

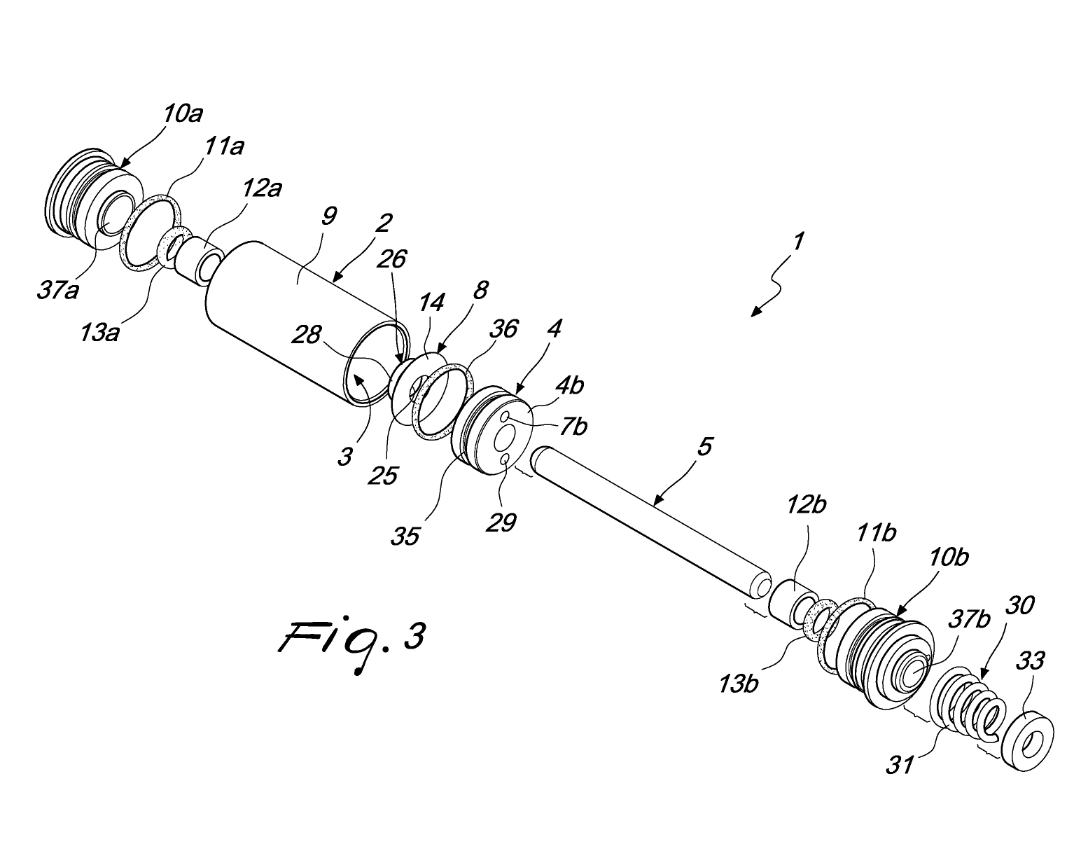

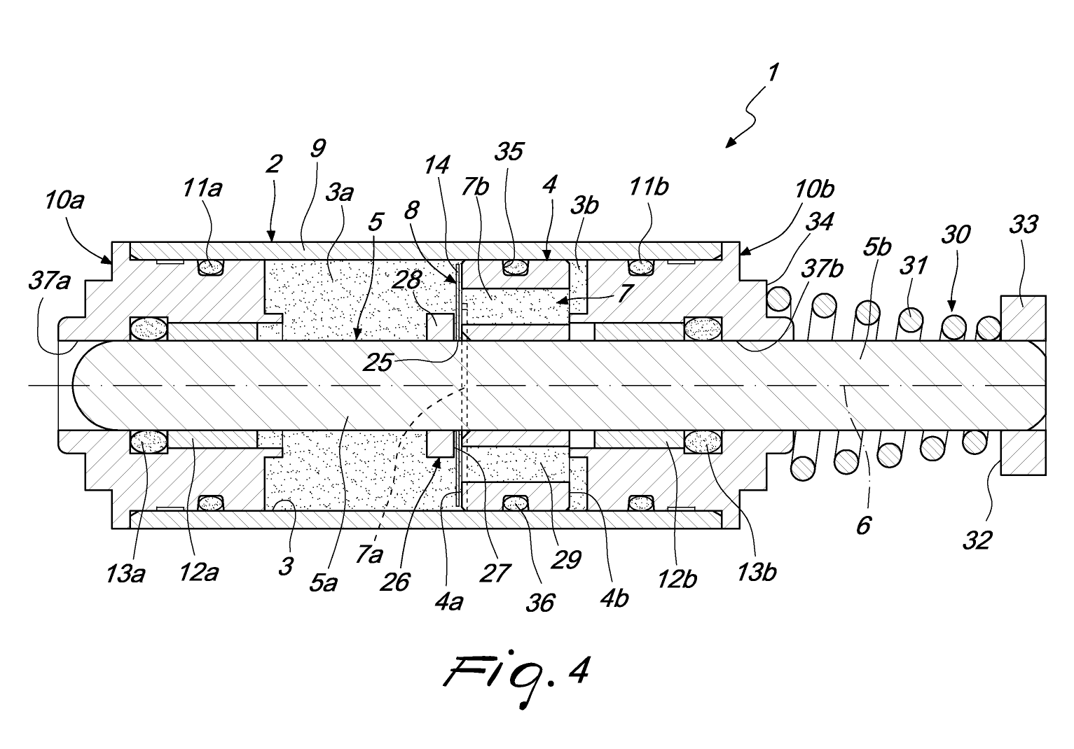

### DETAILED DESCRIPTION

With reference to the figures, the shock absorber according to the invention, which is generally designated by the reference numeral 1, comprises a shock absorber body 2 in which is defined a substantially cylindrical chamber 3 that accommodates, coaxially, a piston 4 that is provided with a stem 5 that protrudes at least from one axial end of the chamber 3.

The piston 4 divides the chamber 3 into two parts 3a and 3b which are arranged on mutually opposite sides with respect to the piston 4 along the axis 6 of the chamber 3 and which are occupied by a fluid, preferably a liquid.

The shock absorber in question has at least one duct 7 connecting the two parts 3a, 3b of the chamber 3 so as to enable the passage of the fluid from one part to the other of the chamber 3 and therefore in order to allow the axial sliding of the piston 4 with respect to the shock absorber body 2.

According to the invention, the connecting duct 7 is defined in the piston 4 and has a calibrated portion 7a thereof which is defined on an end face 4a of the piston 4 which, for clarity, will be referred to hereinafter as “first end face 4a”. The shock absorber according to the invention is provided with means 8 of varying the passage section of the connecting duct 7 that is available for the transit of the fluid. The means 8 of varying the passage section of the connecting duct 7, depending on the direction of axial sliding of the piston 4 in the chamber 3, are engageable or disengageable with the first end face 4a of the piston 4 so as to channel the transit of the fluid along the calibrated portion 7a or so as to also allow the transit of the fluid outside such calibrated portion 7a, as will be better described hereinafter.

More specifically, the shock absorber body 2 is substantially cylindrical and can be made extremely simply, it being composed of a hollow cylinder, which can be constituted simply by a tube that is closed, at its axial ends, by caps or headers 10a, 10b. The headers 10a, 10b are inserted with a cylindrical portion thereof into the axial ends of the hollow cylinder 9 and, interposed between these cylindrical portions and the inner lateral surface of the hollow cylinder 9, are sealing gaskets 11a, 11b, such as for example O-rings.

Defined on the lateral surface of the piston 4, a circumferential groove 35 is defined that accommodates a gasket seal 36, for example an O-ring, which engages with the lateral surface of the chamber 3, i.e. with the inner lateral surface of the hollow cylinder 9.

Preferably, the piston 4 is fixed, for example by way of a forced fit, or by way of welding, gluing or other fixing technique, in an intermediate region of the longitudinal extension of the stem 5 which, in this manner, protrudes coaxially from both of the end faces 4a, 4b of the piston 4, thus protruding from both of the axial ends of the chamber 3, passing through holes 37a, 37b that pass centrally through the headers 10a, 10b.

Arranged inside each one of the headers 10a, 10b, a sliding sleeve 12a, 12b is provided that is passed through, slideably, by the corresponding portion 5a, 5b of the stem 5. Arranged inside each one of the headers 10a, 10b are sealing gaskets 13a, 13b, such as for example O-rings, which engage with the corresponding portion 5a, 5b of the stem 5.

Preferably, the connecting duct 7 comprises: a main portion 7b, which passes through the piston 4 from the first end face 4a to the opposite end face or “second end face” 4b, and the calibrated portion 7a, which extends from the end of the main portion 7b that is defined on the first end face 4a of the piston 4. The calibrated portion 7a is constituted by a groove that is recessed in the flat surface of the first end face 4a of the piston 4.

The means 8 of varying the passage section of the connecting duct 7 comprise a lamina 14 that faces the first end face 4a of the piston 4 and which can move axially with respect to the piston 4 in order to pass from an active position, in which it adheres to the first end face 4a of the piston 4, thus closing the top of the groove that constitutes the calibrated portion 7a, to an inactive position, in which it is spaced from the first end face 4a of the piston 4, and vice versa.

The main portion 7b of the connecting duct 7 has a cross-section for the passage of fluid that is appreciably larger than the cross-section for the passage of fluid of the calibrated portion 7a, obviously when this portion is delimited by the lamina 14 in the active position.

Preferably, the lamina 14 has a substantially disk-like shape and is arranged coaxially to the piston 4. The calibrated portion 7a of the connecting duct 7 has one of its ends arranged in a region of the first end face 4a of the piston 4 that cannot be engaged by the lamina 14, so that the calibrated portion 7a of the connecting duct 7 is always connected with the part 3a of the chamber 3, hereinafter referred to as the “first part”, which is delimited by the first end face 4a of the piston 4, even when the lamina 14 is in the active position and that is to say against the first end face 4a of the piston 4.

Even more preferably, the lamina 14 is passed through centrally by a hole 25 that is coupled, slideably, with the portion 5a of the stem 5 that protrudes from the first end face 4a of the piston 4, so as to pass from the active position to the inactive position, referred to earlier, by sliding along such portion 5a of the stem 5, and means 26 are provided of delimiting the sliding of the lamina 14 away from the first end face 4a of the piston 4.

The means 26 of delimiting the sliding of the lamina 14 are preferably constituted by an axial shoulder 27, which is arranged along the portion 5a of the stem 5 that extends from the first end face 4a of the piston 4 and is defined by a ring 28 that is fitted, fixedly, over such portion 5a of the stem 5.

The lamina 14 has a diameter that is smaller than the diameter of the piston 4 so that there is an annulus region of the first end face 4a of the piston 4 which is in excess with respect to the lamina 14 and which thus is not covered by the lamina 14 when this lamina is in the active position and that is to say against the first end face 4a of the piston 4. The calibrated portion 7a of the connecting duct 7 has one of its ends arranged in this region of the first end face 4a so that the calibrated portion 7a is constantly connected with the first part 3a of the chamber 3.

Advantageously, an auxiliary connecting duct 29 is provided that passes through the piston 4 from one end face to the other. The end of the auxiliary connecting duct 29 that is defined on the first end face 4a of the piston 4 is in a position that is such as to be completely blocked by the lamina 14 when this lamina is in the active position.

Conveniently, reset means 30 are provided which are adapted to keep or move the piston 4 at the axial end of the chamber 3 that faces the second end face 4b of the piston 4.

The reset means 30 are preferably constituted by a reset spring 31 that is fitted on a portion of the stem 5 that protrudes from the chamber 3 and which is interposed between an axial shoulder 32 that is defined along the stem 5, for example by way of a ring 33 that is fitted over and fixed around the stem 5, and an axial shoulder 34 that is defined by the shock absorber body 2.

Preferably, the groove that constitutes the calibrated portion 7a of the connecting duct 7 is obtained by way of a coined region that is executed on the first end face 4a of the piston 4.

Operation of the shock absorber according to the invention is the following.

The shock absorber is fitted so as to be in contact with the item to be damped by way of the end of the portion 5b of stem 5 that extends from the second end face 4b of the piston 4 and that is to say, in the embodiment shown, the end of the portion 5b of stem 5 around which the reset spring 31 is arranged.

In the inactive condition, the piston 4 is kept with its second end face 4b against the header 10b by the action of the reset spring 31, as illustrated in FIG. 4.

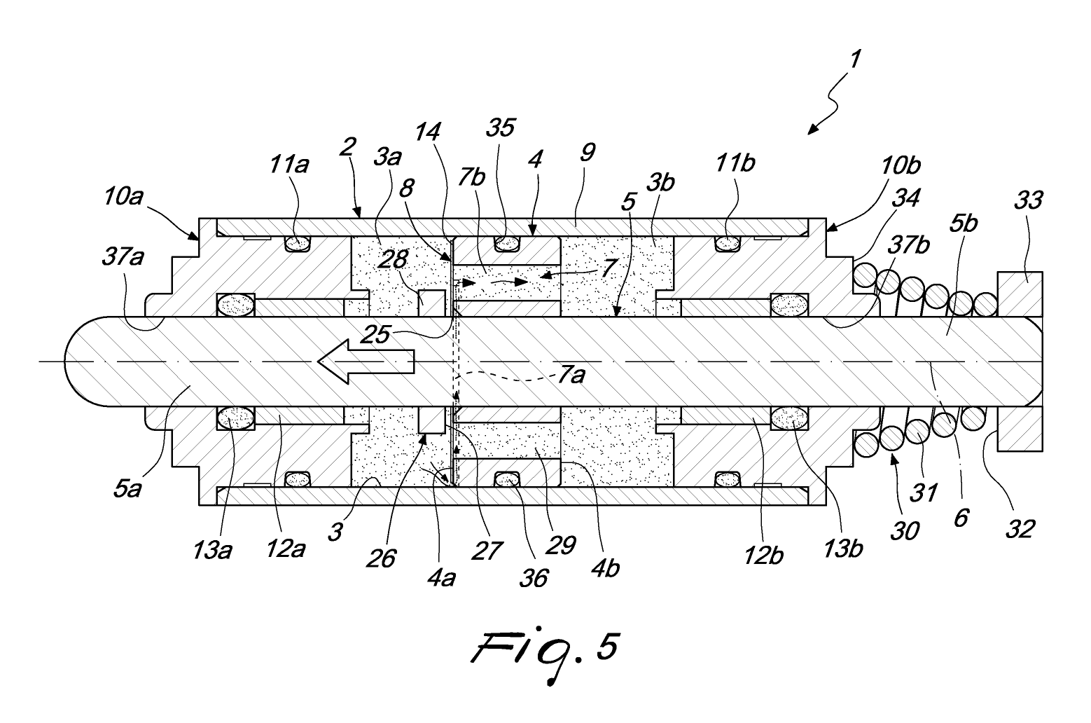

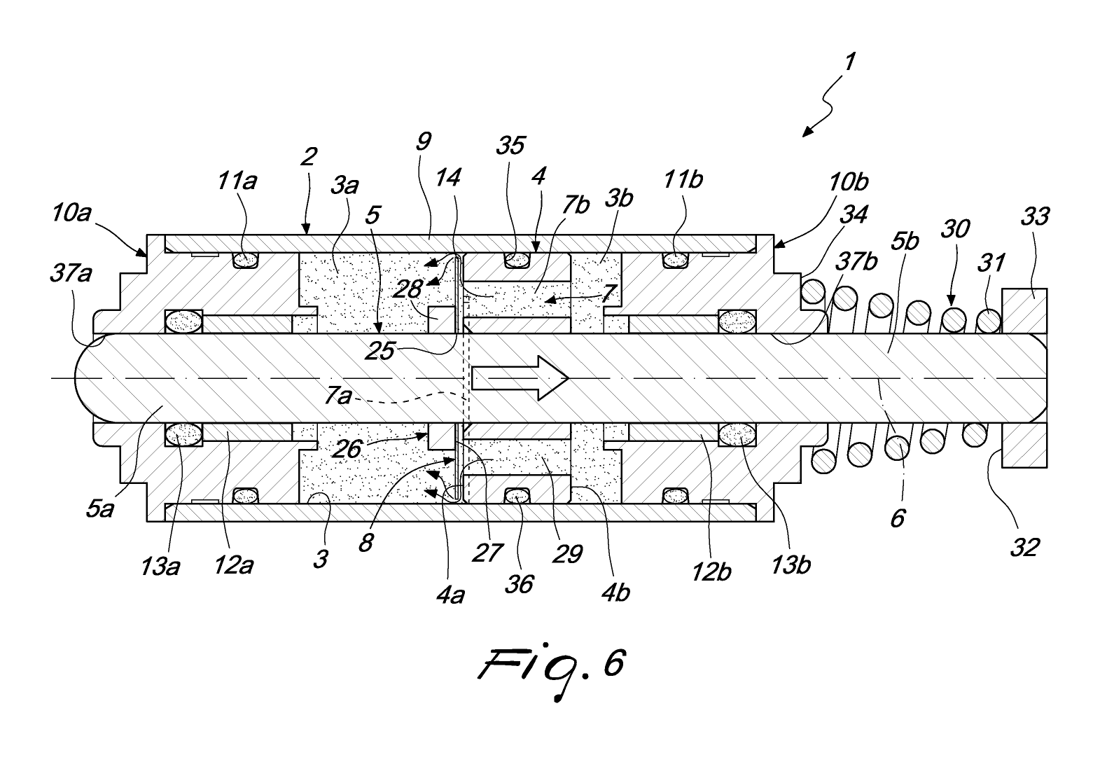

When the item to be damped acts on the stem 5 so as to cause the movement of the piston 4 toward the opposite header 10a, the pressure inside the first part 3a of the chamber 3 increases, while the pressure inside the part 3b of the chamber 3, which is delimited by the second end face 4b of the piston 4 and which hereinafter is referred to as the “second part”, decreases. This difference in pressure causes the transition of the lamina 14 to the active position, and that is to say its axial movement along the stem 5 with consequent engagement against the first end face 4a of the piston 4, as illustrated in FIG. 5.

In this condition, the auxiliary connecting duct 29 is closed completely by the lamina 14 which also covers the top of the groove that constitutes the calibrated portion 7a of the connecting duct 7. In this manner, the connecting duct 7 is connected with the first part 3a of the chamber 3 exclusively through the calibrated portion 7a. The fluid, by way of the increase in pressure generated by the movement of the piston 4, is forced to pass from the first part 3a of the chamber 3 to the second part 3b of the chamber 3, by passing through the calibrated portion 7a of the connecting duct 7. The transit of the fluid through the calibrated portion 7a of the connecting duct 7 dissipates kinetic energy, thus actuating the braking of the piston 4 and thus of the item that is connected to its stem 5.

When the action on the piston 4 that caused its axial movement along the chamber 3 toward the header 10a ceases, the elastic reaction of the reset spring 31, which had been compressed by the previous axial movement of the piston 4, exerts a force on the stem 5 that causes the axial movement of the piston 4 in the direction of the header 10b. This force causes an increase in pressure in the second part 3b of the chamber 3 and a decrease in pressure inside the first part 3a of the chamber 3. This difference in pressure, as illustrated in FIG. 6, causes the transition of the lamina 14 to the inactive position and that is to say its movement away from the first end face 4a of the piston 4, and this movement away is delimited by the presence of the axial shoulder 27 defined by the ring 28. The transition of the lamina 14 to the inactive position and that is to say its separation from the first end face 4a of the piston 4 causes the opening of the top of the groove that constitutes the calibrated portion 7a of the connecting duct 7 and frees the ends of the main portion 7b of the connecting duct 7 and of the auxiliary duct 29 which are defined in the first end face 4a of the piston 4. In this manner, the fluid contained in the second part 3b of the chamber 3, which is under greater pressure, can flow into the first part 3a of the chamber 3 since it has a passage section available that is considerably larger than that of the calibrated portion 7a alone. In fact, the fluid can pass through the entire space that is created between the lamina 14 and the first end face 4a of the piston 4. In this manner, the movement to reset the shock absorber can be done rapidly even when using a reset spring 31 of contained size and reduced rigidity.

It should be noted that any excess stress, even if impulsive, on the piston 4, while this is moving toward the header 10a, can be withstood by the shock absorber according to the invention in that such stresses do not cause a sticking of the piston 4, but instead increase the speed of transit of the fluid through the calibrated portion 7a of the connecting duct 7.

In practice it has been found that the shock absorber according to the invention fully achieves the set aim in that the particular implementation of the calibrated portion of the passage duct on one of the end faces of the piston considerably simplifies the production of the entire shock absorber and makes it possible to obtain a high damping force even with shock absorbers of contained size.

Another advantage of the shock absorber according to the invention is that it offers a reduced reset time although it uses a reset spring of contained size and power.

The shock absorber, thus conceived, is susceptible of numerous modifications and variations, all of which are within the scope of the appended claims; thus, for example, according to the damping effect desired and according to the requirements for use, there can be multiple connecting ducts 7 and multiple calibrated portions 7a.

Moreover, all details may be substituted by other, technically equivalent elements.

In practice the materials employed, provided they are compatible with the specific use, and the dimensions, may be any according to requirements and to the state of the art.

What is claimed is:

1. A fluid-type shock absorber, particularly for doors of electrical household appliances such as ovens, dishwashers or the like or for furniture components such as cabinet doors or drawers, comprising a shock absorber body that has internally a substantially cylindrical chamber that accommodates coaxially a piston provided with a stem that protrudes from at least one axial end of the chamber; the piston dividing the chamber into two parts arranged on mutually opposite sides with respect to the piston along the axis of the chamber and containing a fluid; the piston being accommodated so that it can slide axially within the chamber; at least one duct being provided for connecting the two parts of the chamber in order to allow the transit of the fluid from one part to the other of the chamber for the axial sliding of the piston with respect to the shock absorber body, wherein the at least one connecting duct is defined in the piston and has a calibrated portion thereof that is defined on a first end face of the piston, means being provided for varying the passage section of the connecting duct available for the fluid; the means for varying the passage section of the connecting duct, depending on the direction of axial sliding of the piston in the chamber, being engageable or disengageable with the first end face of the piston in order to channel the transit of the fluid along the calibrated portion or in order to also allow the transit of the fluid outside the calibrated portion.

2. The shock absorber according to claim 1, wherein the connecting duct comprises: a main portion, which passes through the piston from the first end face to its opposite end face or second end face, and the calibrated portion, which protrudes from the end of the main portion that is defined on the first end face of the piston; the calibrated portion being constituted by a groove that is recessed in the first end face of the piston; the means for varying the passage section of the connecting duct comprising a lamina that faces the first end face of the piston and can move axially with respect to the piston from an active position, in which it adheres to the first end face of the piston, closing the top of the groove that constitutes the calibrated portion, to an inactive position, in which it is spaced from the first end face of the piston, and vice versa; the calibrated portion of the connecting duct, with the lamina in the active position, being connected to the part of the chamber that is delimited by the first end face of the piston and having a passage section for the fluid that is smaller than that of the main portion.

3. The shock absorber according to claim 1, wherein the lamina has a substantially disk-like shape and is arranged coaxially to the piston, the calibrated portion of the connecting duct having an end thereof that is arranged in a region of the first end face of the piston that cannot be engaged by the lamina.

4. The shock absorber according to claim 1, wherein the piston is fixed at an intermediate region of the stem; the stem protruding from both of the axial ends of the chamber.

5. The shock absorber according to claim 1, wherein the lamina is crossed by a hole that is coupled slideably with a portion of the stem that protrudes from the first end face of the piston, means being provided for delimiting a sliding of the lamina away from the first end face of the piston.

6. The shock absorber according to claim 5, wherein the means for delimiting the sliding of the lamina comprise an axial shoulder that is defined, along the portion of the stem that protrudes from the first end face of the piston, at a preset distance from the first end face of the piston.

7. The shock absorber according to claim 1, wherein the lamina has a smaller diameter than that of the piston, the calibrated portion of the connecting duct having an end thereof in a region of the first end face of the piston that is in excess with respect to the lamina.

8. The shock absorber according to claim 1, further comprising an auxiliary connecting duct that passes through the piston from one end face to the other, an end of the auxiliary connecting duct defined in the first end face of the piston being blocked by the lamina in the active position.

9. The shock absorber according to claim 2, further comprising reset means adapted to keep or move the piston at the axial end of the chamber that faces the second end face of the piston.

10. The shock absorber according to claim 9, wherein the reset means comprise a reset spring that is fitted on a portion of the stem that protrudes from the chamber and is interposed between an axial shoulder that is defined along the stem and an axial shoulder that is defined by the shock absorber body.

11. The shock absorber according to claim 1, wherein the calibrated portion of the connecting duct is defined by a coined region of the first end face of the piston.

12. The shock absorber according to claim 1, wherein the fluid is constituted by a liquid.
